(19) United States
(12) Patent Application Publication
(10) Pub. No.: US 2011/0162624 A1
(43) Pub. Date: Jul. 7, 2011

(54) DIESEL START-STOP FUEL PRESSURE RESERVE DEVICE

(75) Inventor: Patrick Powell, Farmington Hills, MI (US)

(73) Assignee: DENSO INTERNATIONAL AMERICA, INC., Southfield, MI (US)

(21) Appl. No.: 12/652,303

(22) Filed: Jan. 5, 2010

(51) Int. Cl. F02M 37/04; F02M 37/00

(52) U.S. Cl. 123/509; 123/511

(57) ABSTRACT

An apparatus in a fuel path to assist in delivering fuel to an engine, the apparatus comprising: a fuel tank to contain a fuel and define a first end of the fuel path; a fuel rail to receive fuel and define a second end of the fuel path; a vacuum fuel pump to draw the liquid fuel from the fuel tank; a fuel injection pump to increase a pressure of the liquid fuel to an elevated fuel pressure before delivery of the fuel to the engine; and a check valve in the fuel path to retain fuel at the elevated fuel pressure in the fuel path. A fuel reservoir located between the vacuum fuel pump and the fuel injection pump in the fuel path, the check valve located within the fuel reservoir. The fuel injection pump is located downstream of the fuel reservoir. The fuel reservoir further comprises a fuel inlet and the check valve is located at the fuel inlet.

### FIELD

The present disclosure relates to a structure to maintain pressurized fuel in a fuel line of a fuel injection system.

### BACKGROUND

This section provides background information related to the present disclosure that is not necessarily prior art. Modern fuel systems, such those used in diesel engine fuel systems, may utilize a fuel line from a fuel tank to a fuel vacuum fuel pump to a fuel injection pump and then to an internal combustion engine. Such fuel supply systems have traditionally been employed on engines that are designed to operate even while a vehicle in which the engine is installed is stopped at a traffic light and when the vehicle is in traffic but not moving. However, modern vehicle manufacturers desire to offer vehicles with engines capable of automatically shutting off when such vehicles are stopped at traffic lights or are in traffic but not moving because shutting engines off whenever possible saves fuel. That is, operating an engine when unnecessary, wastes fuel. Current diesel engine technology for quickly starting a diesel engine is lacking a sufficiently pressurized fuel line upstream of a high pressure diesel fuel injection pump and maintaining a sufficient volume of fuel during starting and engine running until a vacuum fuel pump can supply fuel to the high pressure diesel fuel injection pump. Thus, what is needed then is a device or system that is capable of maintaining sufficient pressure in a fuel line upstream of a high pressure diesel fuel injection pump and supplying a sufficient volume of fuel to maintain fuel demand by the engine until a vacuum fuel pump can supply such volume of fuel.

### SUMMARY

This section provides a general summary of the disclosure, and is not a comprehensive disclosure of its full scope or all of its features. An apparatus to assist in delivering fuel to an engine may reside in a fuel path and employ a fuel tank to contain a liquid fuel (e.g. diesel fuel), a vacuum fuel pump to draw the fuel from the fuel tank, a fuel injection pump to increase a pressure of the liquid fuel to an elevated fuel pressure before delivery of the fuel to the engine, a fuel reservoir located between the vacuum fuel pump and the fuel injection pump in the fuel path, and a check valve in the fuel path to retain fuel at the elevated fuel pressure in the fuel reservoir. Other structures may be part of such an apparatus.

The fuel reservoir may further possess a fuel inlet and a check valve located at the fuel inlet; however, the check valve may be located within the fuel reservoir. The fuel injection pump may be located downstream of the fuel reservoir and the vacuum fuel pump may be located upstream of the fuel reservoir. Only a single fuel line is located between the vacuum fuel pump and the fuel reservoir. Only a single fuel line is located between the fuel injection pump and the fuel reservoir. Fuel pressure in the fuel reservoir and in the fuel line between the fuel reservoir and the fuel injection pump may be equal. The fuel pressure in the fuel reservoir may be greater than a fuel pressure in the fuel line between the vacuum fuel pump and the fuel reservoir.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle depicting a fuel system in phantom;

FIG. 2 is a schematic view of a vehicle fuel system, such as a diesel fuel system; and

FIG. 3 is an enlarged view of a fuel reservoir and check valve in accordance with the present disclosure.

Corresponding reference numerals indicate corresponding parts throughout the several views of the drawings.

### DETAILED DESCRIPTION

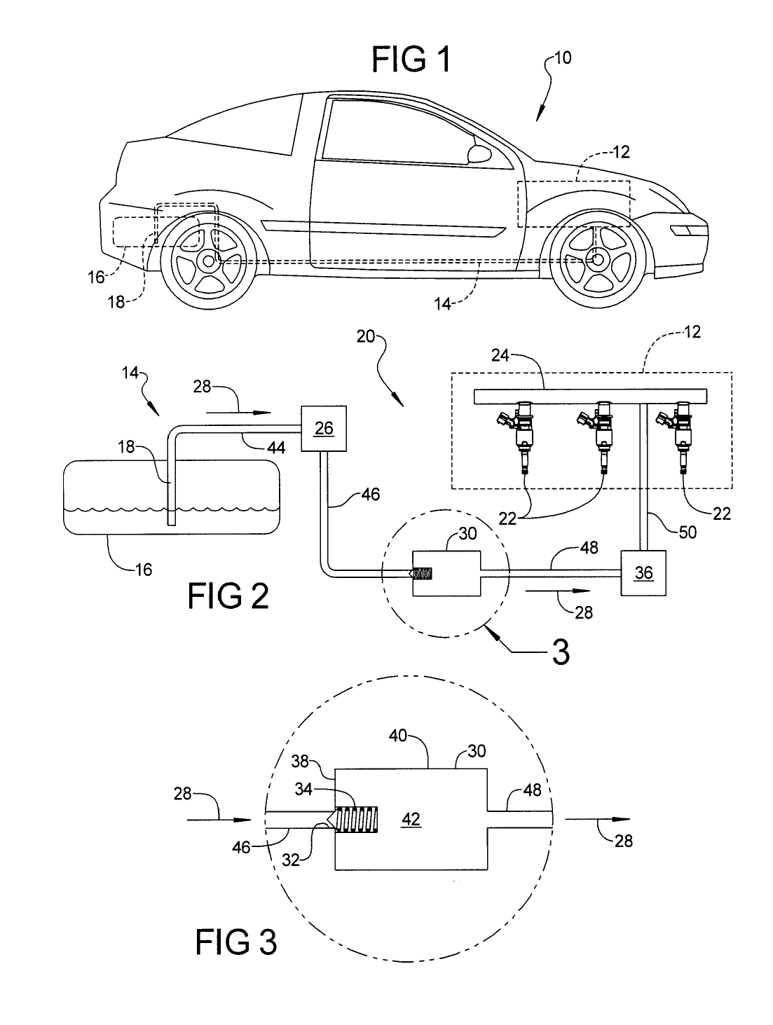

Example embodiments of the present teachings may be applied to gasoline, diesel and other liquid fuel systems. Such embodiments will be described with reference to FIGS. 1-3. FIG. 1 depicts a vehicle 10, such as an automobile, having an engine 12, a fuel supply line 14, a fuel tank 16, and a fuel pickup tube 18. Fuel pickup tube 18 mounts within or protrudes into fuel tank 16 and is normally submerged in or surrounded by varying amounts of liquid fuel.

FIG. 2 depicts a fuel supply system 20 employing fuel injectors 22. Fuel supply system 20 may supply fuel to engine 12 through a fuel line 14, which may carry fuel between fuel pickup tube 18 and a common rail 24. More specifically, fuel line 14 may be a general reference to a group of multiple, separate fuel lines 44, 46, 48, 50, which may be individually referred to as fuel lines or intermediate fuel lines. Once fuel reaches common rail 24, fuel may pass into individual fuel injectors 22 before being sprayed or injected into individual combustion chambers of internal combustion engine 12. To move fuel from within fuel tank 16 to common rail 24, a fuel pump within fuel tank 16 is not necessary. Instead, a vacuum fuel pump 26, also known as a mechanical fuel pump, may reside within fuel supply line 14 and draw fuel into fuel pickup tube 18 to cause fuel to flow through fuel line 44 in accordance with arrow 28 from fuel tank 16 to vacuum fuel pump 26. Upon being drawn through vacuum fuel pump 26, fuel then may pass into a fuel line 46 which fluidly links vacuum fuel pump 26 and fuel reservoir 30, which may define an interior volume 42 to contain fuel. Fuel line 46 may be the only fluid path between vacuum fuel pump 26 and fuel reservoir 30. That is, it is conceivable that no other components may reside between or link vacuum fuel pump 26 and fuel reservoir 30. Fuel reservoir 30 is a fuel storage location for fuel between vacuum fuel pump 26 and fuel injection pump 36. To prevent backflow from fuel reservoir 30 toward vacuum fuel pump 26 and toward fuel tank 16, within fuel reservoir 30 and resident in fuel inlet 32 of fuel reservoir 30, a check valve 34, which may be a one-way check valve, may reside. With continued reference to FIG. 2 and including reference to FIG. 3, while vacuum fuel pump 26 is drawing fuel from fuel tank 16, fuel passes through check valve 34 and into fuel reservoir 30 and proceeds to fuel injection pump 36, which may also be referred to a diesel piston pump. Fuel travels from fuel reservoir 30 and proceeds to fuel injection pump 36 through a fuel line 48. Fuel line 48 may be the only fluid path between fuel reservoir 30 and fuel injection pump 36. That is, it is conceivable that no other components may reside between or link fuel reservoir 30 and fuel injection pump 36. Upon fuel entering fuel injection pump 36, fuel is pressurized to a pressure higher than that upstream of fuel injection pump 36 and pumped to common rail 24 through fuel line 50. Fuel leaves common rail 24 and passes into injectors 22 of engine 12.

As depicted in FIG. 2, fuel reservoir 30 may be located in fuel supply line 14 between fuel line 46 and fuel line 48, and with regard to fuel flow, between vacuum fuel pump 26 and fuel injection pump 36. Because fuel reservoir 30 is arranged between vacuum fuel pump 26 and fuel injection pump 36, a supply of pressurized fuel from fuel reservoir 30 for fuel injection pump 36 may be ensured for proper starting of engine 12, such as during time periods when engine 12 is not operating. Check valve 34 closes and ensures that fuel and pressure are maintained in fuel reservoir 30 when vacuum fuel pump 26 is turned off, such as when engine changes from a running engine to a non-running engine, such as in a start-stop engine system employed in a vehicle such as vehicle 10. Stated differently, when vacuum fuel pump 26 is operating fuel line 46 contains a volume of flowing fuel with enough pressure to cause check valve 34 to open and permit fuel to flow into fuel reservoir 30. However, when vacuum fuel pump 26 is not operating fuel line 46 contains a volume of non-flowing fuel but with not enough pressure to cause check valve 34 to remain open; thus, check valve 34 closes as fuel and pressure escape to fuel tank 16 upstream of check valve 34. However, downstream of check valve 34, fuel and pressure are maintained when engine 12 is not operating.

An advantage of fuel reservoir 30 with check valve 34 is that when a vehicle equipped with a start-stop engine system employs reservoir 30 with check valve 34, a supply of pressurized fuel is immediately able to be drawn by, or supplied to, fuel injection pump 36 to ensure a rapid engine start and continuous engine running until vacuum fuel pump 26 draws additional, necessary fuel and supplies such fuel to fuel reservoir 30. A rapid engine start is an engine start that is faster, or accomplished in less time, than an engine start in which no supply of pressurized fuel is available to fuel injection pump 36, such as when fuel reservoir 30 and check valve 34 are not present. In a non-rapid engine start, pressurized fuel must be supplied by vacuum fuel pump 26, which involves some internal of time. Fuel reservoir 30 with check valve 34 may be located on a side surface 38, top surface 40, or other surface of fuel reservoir 30.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An apparatus in a fuel path to assist in delivering fuel to an engine, the apparatus comprising:
a fuel tank to contain a fuel;
a vacuum fuel pump to draw the liquid fuel from the fuel tank;
a fuel injection pump to increase a pressure of the liquid fuel to an elevated fuel pressure before delivery of the fuel to the engine;
a fuel reservoir located between the vacuum fuel pump and the fuel injection pump in the fuel path; and
a check valve in the fuel path to retain fuel at the elevated fuel pressure in the fuel reservoir.

2. The apparatus of claim 1, wherein the fuel reservoir further comprises a fuel inlet and the check valve is located at the fuel inlet.

3. The apparatus of claim 2, wherein the check valve is located within the fuel reservoir.

4. The apparatus of claim 3, wherein the fuel injection pump is located downstream of the fuel reservoir.

5. The apparatus of claim 4, wherein the vacuum fuel pump is located upstream of the fuel reservoir.

6. The apparatus of claim 5, wherein only a fuel line is located between the vacuum fuel pump and the fuel reservoir.

7. The apparatus of claim 6, wherein only a fuel line is located between the fuel injection pump and the fuel reservoir.

8. The apparatus of claim 7, wherein a fuel pressure in the fuel reservoir and in the fuel line between the fuel reservoir and the fuel injection pump are equal.

9. The apparatus of claim 8, wherein the fuel pressure in the fuel reservoir is greater than a fuel pressure in the fuel line between the vacuum fuel pump and the fuel reservoir.

10. An apparatus in a fuel path to assist in delivering fuel to an engine, the apparatus comprising:
a fuel tank to contain a fuel and define a first end of the fuel path;
a fuel rail to receive fuel and define a second end of the fuel path;
a vacuum fuel pump to draw the liquid fuel from the fuel tank;
a fuel injection pump to increase a pressure of the liquid fuel to an elevated fuel pressure before delivery of the fuel to the engine; and
a check valve in the fuel path to retain fuel at the elevated fuel pressure in the fuel path.

11. The apparatus of claim 10, further comprising:
a fuel reservoir located between the vacuum fuel pump and the fuel injection pump in the fuel path, the check valve located within the fuel reservoir.

12. The apparatus of claim 11, wherein the fuel injection pump is located downstream of the fuel reservoir.

13. The apparatus of claim 12, wherein the fuel reservoir further comprises a fuel inlet and the check valve is located at the fuel inlet.

14. The apparatus of claim 13, wherein the vacuum fuel pump is located upstream of the fuel reservoir.

15. The apparatus of claim 14, wherein only a fuel line is located between the vacuum fuel pump and the fuel reservoir.

16. The apparatus of claim 15, wherein only a fuel line is located between the fuel injection pump and the fuel reservoir.

17. The apparatus of claim 16, wherein a fuel pressure in the fuel reservoir and in the fuel line between the fuel reservoir and the fuel injection pump are equal.

18. The apparatus of claim 17, wherein the fuel pressure in the fuel reservoir is greater than a fuel pressure in the fuel line between the vacuum fuel pump and the fuel reservoir.
